(19) United States
(12) Patent Application Publication
(10) Pub. No.: US 2013/0315683 A1
(43) Pub. Date: Nov. 28, 2013

(54) Adjusting device for a rotary tool

(71) Applicant: Johne & Co. Prazisionswerkzeuge GmbH, (US)

(72) Inventor: Frank Johne, Grossenhain (DE)

(73) Assignee: JOHNE & CO. PRAZISIONSWERKZEUGE GMBH, Dorsten (DE)

(21) Appl. No.: 13/670,321

(22) Filed: Nov. 6, 2012

(30) Foreign Application Priority Data
Nov. 8, 2011 (DE) 10 2011 055 135.2

(51) Int. Cl. B23B 29/034

(52) U.S. Cl. CPC B23B 29/034
USPC 408/16

(57) ABSTRACT

The adjusting device for a rotary tool contains a flexible spring, with radially adjustable cutting plates. The holder can be deflected relative to a support by a setscrew, with a pressure zone on a threadless circumferential part jointly with a complementary zone on the holder forming a wedge surface pair. During its adjustment, the cutting plate experiences a radial displacement. The annular scale has graduation marks and at least one orientation mark A conical section of the adjusting screw (8) has an angle (α/2) of 4.5 to 24°, the pitch of the setscrew (8) is 0.1 to 0.3 mm and the adjustment range is 0.1 to 5 mm.

The invention relates to an adjusting device for a rotary tool for the machining treatment of bores, in particular a short clamping holder having radially finely adjustable standard cutting plates.

Known from DE 35 30 696 A1 is a rotary tool for the machining treatment of bores in which the cutting plate screwed onto the resilient holder there can be deflected under pre-tension with the aid of a parallel flexible spring. The holder itself is joined by welding or similar to a cassette-like base of the holder, the spring and its adjusting device so that a pre-set cassette can be installed completely into a boring bar. The cutting plate can also be adjusted in the built-in state of the cassette. Problems arise with systems of this type for producing small bores since the cassette per se already has dimensions which are not suitable for small bores. Furthermore, a wedge body must first be moved by the adjusting screw, which for its part then adjusts the holder. As a result of this arrangement, an additional play necessarily results. The stick-slip effect is certainly reduced to a minimum but at best radial adjustments in the range of 10 μm or greater can thus be achieved.

Known from EP 0 968 783 B1 is a short clamping holder with radial adjustment which contains a holder which has at least one receptacle for a cutting plate in its front part and in the region between its ends, a hole for the passage of a fastening screw, with which it can be fixed on a carrier, in particular a boring bar. On its part carrying the cutting plate the holder can be deflected elastically relative to a support by means of an adjusting device with a setscrew. The pressure zone located on the threadless circumferential part of the setscrew jointly with a complementary zone on the holder forms a wedge surface pair. The adjusting device with the setscrew connected to the base part by means of a threaded pin has a scaling. The holder is provided with a break and forms a parallel-flexible spring arrangement so that the cutting plate substantially experiences a parallel displacement in relation to the cutting edge during its adjustment.

Both the arrangements according to DE 35 30 696 A1 and EP 0 968 783 B1 are reliable and suitable for series production but do not meet the increased requirements for the readability and accuracy of the adjustments. They are therefore not in a position to reliably implement a delivery of 1 μm in radius.

These high requirements on the readability and accuracy of the adjustments have hitherto only been achieved by fine adjustment systems with measurement and display of the relative adjustment paths. These systems for bore machining are based, like DE 35 30 696 A1 and EP 0 968 783 B1, on the principle of applying pressure by means of a setscrew on a parallel flexible spring under pre-tension and thereby achieving a deflection of the cutting plate screwed on the resilient holder there.

According to the “Rigibore Smartbore” fine adjustment system known from www.rigibore.com/smartbore.htm, the delivery is accomplished by means of the setscrew with a digital adjusting key which has a rechargeable battery. The relative adjustment path can be read off on a digital display on the adjusting key or via a radio connection on an external display device.

The “Rigibore Active Edge” fine adjustment system known from www.rigibore.com/active-edge.htm achieves a contactless fine adjustment of a plurality of cutting edges independently of one another by radio transmission with a delivery accuracy of 1 μm in diameter. The fine adjustment can take place automatically if connected to a measuring station or a measuring sensor. With contactless measurement of the current cutting edge setting and data transfer to a measuring and regulating station, a radio transmission for the required fine adjustment of the setscrew is accomplished via an interface by means of a controllable electromagnetic drive which is located directly on the tool.

Both systems are highly accurate, can be used flexibly, allow automatic fine adjustment and despite using electronics, require no modification and cabling of the machine. However, on account of rough conditions and therefore possible interference, e.g. due to metal dust, conducting liquids or electromagnetic interference fields and therefore lower reliability compared with purely mechanical systems, these electronic adjusting system cannot be used everywhere.

The invention is based on the problem of modifying an adjusting device for a rotary tool for the machining treatment of bores, in particular a short clamping holder with radially finely adjustable standard cutting plates, having a holder configured as a flexible spring and a setscrew with a cone for radial adjustment to an axis, a threaded pin for connection to the base part and a scaling such that the readability, reliability and accuracy is increased with a simple purely mechanical solution suitable for small drill hole diameters.

This object is solved by an adjusting device having the features of patent claim 1. Further developments of the invention are contained in subclaims 2 to 7.

The adjusting device for a rotary tool for the machining treatment of bores, in particular a short clamping holder having radially finely adjustable standard cutting plates contains a holder which has at least one receptacle for a cutting plate and a hole for passage of a fastening screw for fixing on a carrier. On its part carrying the cutting plate, the holder can be deflected elastically relative to a support by means of an adjusting device designed as a setscrew, with a pressure zone on a threadless circumferential part jointly with a complementary zone on the holder forming a wedge surface pair, which is connected to the base part by means of a threaded pin and which is provided with a scale. The holder is provided with a break and forms a parallel-flexible spring arrangement so that the cutting plate substantially experiences a radial displacement in relation to the cutting edge during its adjustment.

Various possible designs exist for the break provided for the flexible spring configuration, thus for example, with a parallel flexible spring, Z-shaped, rectangular or U-shaped. Those with a recess in corner regions which prevent notch stresses are expedient. In a very favourable embodiment the break has the shape of a U with central fastening tongue.

According to the invention, the annular or plate-shaped scale applied to the head of the setscrew has 25 to 60 graduation marks and on the base body an orientation mark is provided for the scaling. The wedge surface on the setscrew has an angle α/2 of 4.5 to 24°, preferably 5.17°. The pitch of the threaded pin of the setscrew is 0.1 to 0.3 mm, preferably 0.25 mm. The radial adjustment range is 0.1 to 5 mm, preferably 0.25 mm.

The adjusting device according to the invention is small, simply configured, easy to adjust and read, very reliable due to the use of exclusively mechanical elements and reaches a high accuracy of 1 μm radius during delivery. The so-called setting angle experiences no impermissible variation. This adjusting device ensures that plate wear, plate tolerances and clamping errors are safely compensated and high-precision machining processes can be reliably carried out.

The invention is explained in detail hereinafter for an exemplary embodiment. In the relevant drawings:

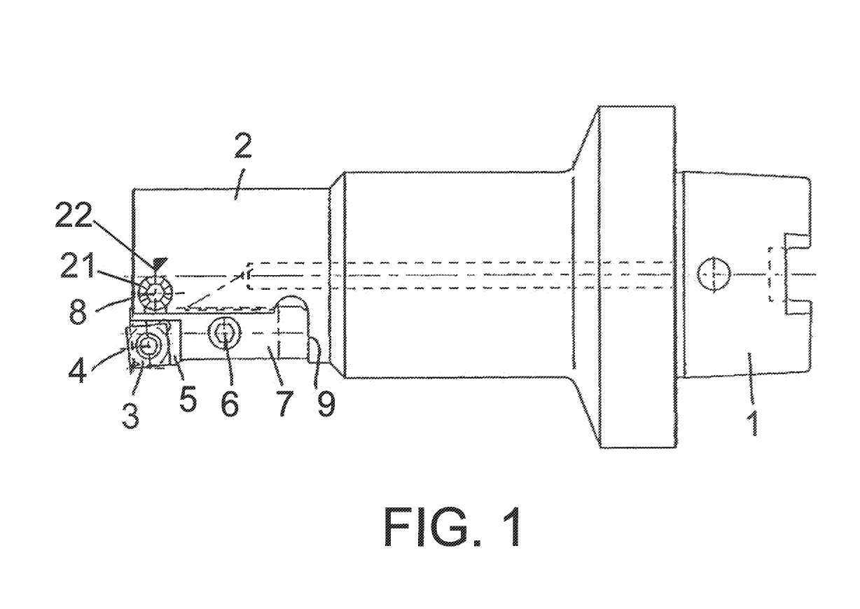

FIG. 1 shows a standardized short clamping holder with adjusting device in schematic view;

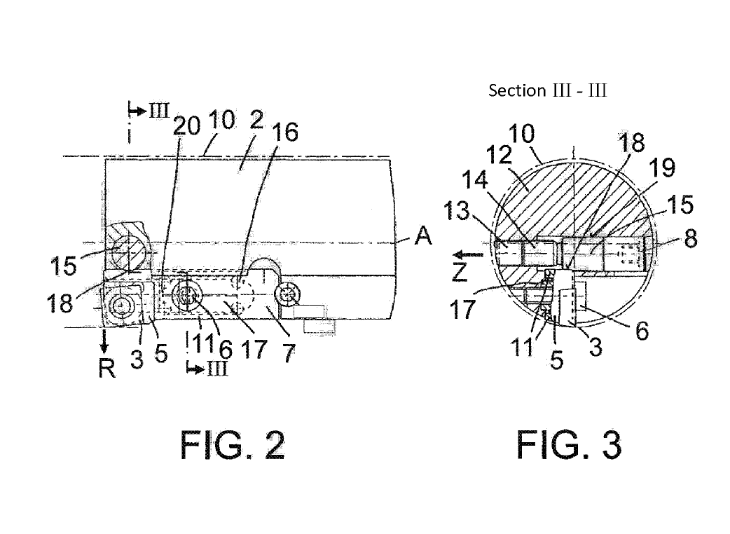

FIG. 2 shows an enlarged plan view with partial section in slightly modified design similar to FIG. 1;

FIG. 3 shows a section III-III according to FIG. 2 through an adjusting device according to the invention;

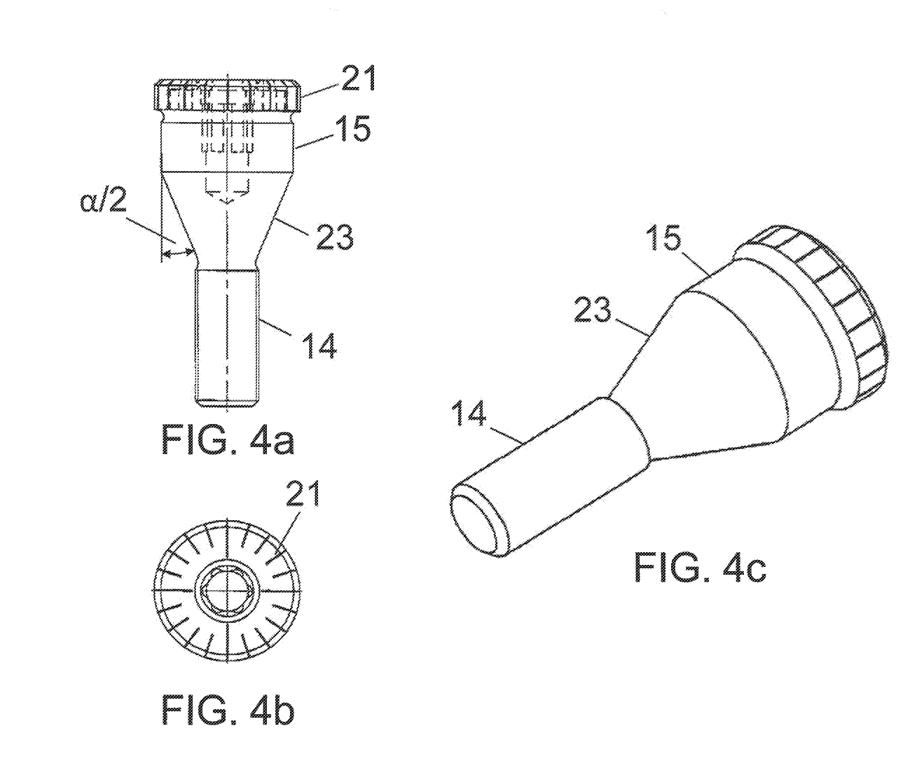

FIGS. 4a-4c show diagrams of a one-piece setscrew;

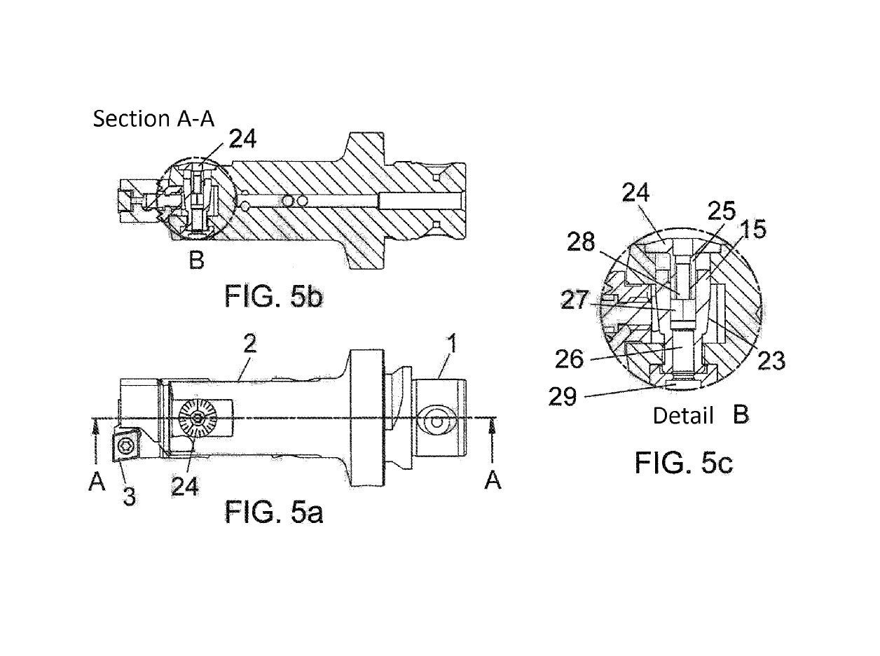

FIGS. 5a-5c show diagrams of an adjusting device with divided setscrew.

The adjusting device according to the invention can be used in various rotary tools for the machining treatment of bores, which contain radially finely adjustable standard cutting plates. A requirement is that these have a plate holder which contains a flexible spring arrangement adjustable by means of a setscrew and the setscrew contains a cone. An arrangement of a short clamping holder with radial adjustment according to EP 0 968 783 B1 is selected as an exemplary embodiment.

FIG. 1 shows a short clamping holder with machine shaft 1 and tool shaft 2 with holder 5 on which a cutting plate 3 is fixed by a fastening screw 4. The holder 5 is fixed together with a cover 7 by means of fastening screw 6 in the tool shaft 2 and is supported against one edge 9 of the tool shaft 2. The setscrew 8 enables a deflection of the cutting plate 3 in order to set a slightly different radius of a bore to be produced. The delivery can be made according to the graduation marks on the scale 21 compared with the at least one orientation mark 22. The scale 21 can be applied to the setscrew 8 or the base body 12 and the at least one orientation mark 22 can be applied accordingly to the base body 12 or the setscrew 8. In order to achieve a high delivery precision, the scale 21 should have at least 25, in particular cases up to 60 graduation marks.

FIG. 2 shows the tool shaft 2 similar to FIG. 1 with its axis A, which at the same time is the axis of rotation where the tool produces a bore 10 by means of the cutting plate 3, which is variable in diameter due to deflection of the cutting plate 3 in direction R. The deflection of the cutting plate 3 in direction R is achieved by the setscrew 8 (FIG. 3) which is in contact with a complementary pressure zone 18 of the holder 5 on the conical section 23 of the threadless part 15. In order to achieve a high precision of the adjusting process, the wedge angle α/2 on the threadless conical section 23 of the setscrew 8 is 4.5° to 24°, preferably 5.17°. By adjustment of the setscrew 8 with the conical pressure zone of the threadless part 15 (FIG. 3) in direction Z of the threaded hole 13 in the base body 12 of the tool shaft 2 and corresponding displacement of the threaded pin 14 of the setscrew 8 in the tapped hole 13, the pressure zone of the threadless part 15 migrates in direction Z and thus presses onto the pressure zone 18 of the holder 5 with the consequence of a radial adjustment of the cutting plate 3. The pressure zone 18 is in this case supported on the base body 12 of the tool shaft 2 with its shoulder 19 lying opposite the holder 5. The holder 5 substantially consists of a part on which the cutting plate 3 is fastened and two legs 11 delimited by a U-shaped joint 20 which interconnects the stress relief bores 16 on three sides of the central tongue 17 and thus forms the parallel flexible spring. The tongue 17 is fixed by means of fastening screw 6 in the base part 12 of the tool shaft 2, where the cutting plate 3 as a result of the joint arrangement can execute a parallel movement in direction R if the adjustment of the setscrew 8 allows this. The holder 5 is adjustable in the axial direction with respect to tool shaft 2 in order to thus be able to position the cutting plates 3 in a certain position relative to the tool shaft 2. This is appropriate if, for example, on the opposite side of the tool shaft 2, another cutting plate 3 is arranged at an axial distance from the head of the tool shaft 2 in order to thus produce a two-stage bore. In order that a certain axial setting by the setscrew 8 is possible, the fastening screw 6 sits in an oblong hole in the tongue 17. The parallel flexible spring or the holder 5 is covered by a cover 7 so that the joint 20 cannot be clogged by swarf and foreign bodies.

FIGS. 4a to 4c show a one-piece setscrew 8 with a threadless part comprising a cylindrical part 15 and a conical section 23 with a wedge angle α/2 as well as a threaded pin 14. A scale 21 is attached to the head of the setscrew 8.

For larger adjustment paths a divided setscrew with holder of the scale on its head is expedient. Various designs are possible. The scale 21 is annular or plate-shaped and separate from the setscrew 8 as a separate part but positively connected to this. Thus, a degree of freedom is only allowed in one direction (axial) so that a rotary movement of the scale 21 is transmitted 1:1 directly to the setscrew 8. An exemplary embodiment of a divided setscrew 8 is shown in FIGS. 5a-5c. FIG. 5a shows a short clamping holder which contains a machine shaft 1 and a tool shaft 2 with a radially finely adjustable cutting plate 3 and a scale plate 24. The section A-A according to FIG. 5b shows the divided setscrew 8 with the scale plate 24 on the adjusting device for the short clamping holder which is shown in detail in the detail B according to FIG. 5c. The divided setscrew 8 according to FIG. 5c has central longitudinal bores 25, 26, with larger diameter starting from the head and with smaller diameter from the end, where the bore 26 having the smaller diameter is deeper than the bore 25 having the larger diameter. A hexagon socket is introduced into the bore 26 having the smaller diameter from the side of the bore 25 having the larger diameter so that in the central region a receptacle 27 rigidly connected to the setscrew 8 is formed for a hexagonal shaft 28 firmly connected to the scale plate 24. A screw guided through the bore 26 having the smaller diameter and covered with a cover 29 is used for holding the scale plate 24. An adjustment of the scale plate 24 is transmitted by positive entrainment via the hexagonal shaft 28 to the receptacle 27 with the hexagon socket and therefore to the conical section 23 of the setscrew 8.

The thread of the setscrew 8 itself and/or the complementary thread in the tapped hole 13 in the base body 12 are set largely free from play or made free from play by special measures such as HELICOIL inserts, slits of the threaded bushing or coating, treatment of the threaded flanks, the pair of threads. The pitch of the thread is 0.1 mm to 0.25 mm, preferably 0.25 mm. In order to achieve the high precision of deliveries, the threadless part 15, the conical part 23 and the threaded pin 14 of the setscrew 8 must have a concentricity of less than 0.003 mm.

The holder 5 is particularly advantageously already in the non-deflected state under pre-tension so that freedom from play is ensured from the outset. This can be achieved whereby the holder 5 forming a spring is screwed firmly to the base body 12 of the tool shaft 2 and thereby abuts directly against the setscrew 8.

In a particularly expedient embodiment, the setscrew 8 with the holder 5 has such a wedge surface pairing 15, 18 that no self-inhibition can occur. As a result, upon turning the setscrew 8 in the loosening direction, the wedge surfaces slide as a result of the high pre-tension, i.e. the holder 5 always remains in abutment on the setscrew 8. In any case the setscrew 8 sits approximately vertically to the axis of rotation and approximately vertically to the cutting plate plane and is arranged as close as possible behind the cutting edge in order to be able to apply the adjusting force without large moments directly on the holder 5 at the height of the cutting plate 3.

The wedge surface pairing between holder 5 and setscrew 8 can, for example, be produced by a spherical or conical section 23 of the setscrew 8 paired with a vertical section of the holder 5 but also conversely or by mixed shapes. What is important is the direct contact of the elements and their direction of action to one another.

With such an adjusting device it is possible to deflect the cutting plate radially more accurately than 1 pm and accordingly produce precise bores. The repeatability is so exact that the movement of the setscrew 8 can be assigned a corresponding radial adjustment of the cutting plate 3 on the annular scale 21 arranged thereon relative to the orientation mark 22 on the base body 2. A radian measure of 1 mm on the setscrew 8 corresponds, for example, to 1/1000 mm on the cutting edge. This repetition accuracy is the requirement to meet the quality conditions required by DIN/ISO 9000 ff with inexpensive tools such as a standard short clamping holder.

Account is therefore taken of a requirement of the market to provide inexpensive tools for series production with high functional accuracy and production reliability. A DIN standard short clamping holder can be modified with the invention so that a defined fine adjustment of the cutting plate can be made with this tool.

### REFERENCE LIST

1 Machine shaft
2 Tool shaft
3 Cutting plate
4, 6 Fastening screw
5 Holder
7 Cover of 5
8 Setscrew
9 Edge of 2
10 Bore
11 Leg of 5
12 Base body of 2
13 Tapped hole
14 Threaded pin
15 Threadless part of 8
16 Stress relief bore
17 Central tongue
18 Pressure zone of 5
19 Shoulder of 15
20 U-shaped join
21 Scale
22 Orientation mark for 21
23 Conical section of 15
24 Scale plate
25 Bore with larger diameter
26 Bore with smaller diameter
27 Receptacle with hexagon socket
28 Hexagonal shaft
29 Cover
Z,R Direction
α/2 Wedge angle

1. An adjusting device for a rotary tool for the machining treatment of bores, in particular a short clamping holder having radially finely adjustable standard cutting plates comprising a holder which has at least one receptacle for a cutting plate and a hole for passage of a fastening screw for fixing on a carrier wherein on its part carrying the cutting plate, the holder can be deflected elastically relative to a support by means of an adjusting device designed as a setscrew, with a pressure zone on a threadless circumferential part jointly with a complementary zone on the holder forming a wedge surface pair, which is connected to the base part by means of a threaded pin and which is provided with a scale, the holder is provided with a break and forms a parallel-flexible spring arrangement so that the cutting plate substantially experiences a radial displacement in relation to the cutting edge during its adjustment, characterized in that the annular or plate-shaped scale (21) applied to the head of the setscrew (8) has 25 to 60 graduation marks and on the base body (12) at least one orientation mark (22) is provided for the scaling, the conical section (23) of the threadless part (15) of the adjusting screw (8) has an angle (α/2) of 4.5 to 24°, the pitch of the threaded pin of the setscrew (8) is 0.1 to 0.3 mm and the radial adjustment range is 0.1 to 5 mm.

2. The adjusting device according to claim 1, characterized in that the angle (α/2) of the conical section (23) on the setscrew (8) is 5.17°.

3. The adjusting device according to claim 1, characterized in that the pitch of the thread of the setscrew (8) is 0.25 mm.

4. The adjusting device according to claim 1, characterized in that the radial adjustment range is 0.25 mm.

5. The adjusting device according to claim 1, characterized in that the scale (21) is applied to the base body (12) and the at least one orientation mark (22) is applied to the head of the setscrew (8).

6. The adjusting device according to claim 1, characterized in that the scale (21) is separate from the setscrew (8) but connected positively to this.

7. The adjusting device according to claim 1, characterized in that the threadless part (15), the conical section (23) and the threaded pin (14) of the setscrew (8) have a concentricity of less than 0.003 mm.
